(19) United States
(12) Patent Application Publication
(10) Pub. No.: US 2002/0144587 A1
(43) Pub. Date: Oct. 10, 2002

(54) Virtual music system

(76) Inventors: Bradley J. Naples, Hanover, NH (US); Kevin D. Morgan, Nashua, NH (US)

Correspondence Address: BRIAN J. COLANDREO, Fish & Richardson P.C., 225 Franklin Street, Boston, MA, 02110-2804, US

(21) Appl. No.: 09/900,287

(22) Filed: Jul. 6, 2001

Related U.S. Application Data
(60) Provisional application No. 60/282,420, filed on Apr. 9, 2001.
(60) Provisional application No. 60/282,549, filed on Apr. 9, 2001.
(60) Provisional application No. 60/288,876, filed on May 4, 2001.
(60) Provisional application No. 60/288,730, filed on May 4, 2001.

(51) Int. Cl. G10H 1/26

(52) U.S. Cl. 84/609

(57) ABSTRACT

A method for playing a multipart data file on an interactive karaoke system includes receiving a multipart data file from a source. This multipart data file includes an interactive virtual instrument object and a global accompaniment object. The global accompaniment object includes at least a first synthesizer control file and at least a first sound recording file. This method generates at least one virtual instrument required to process the multipart data file and prompts the user of at least one virtual instrument to provide an input stimuli to the virtual instrument input device associated with that virtual instrument. This generates a performance for that virtual instrument. The method then combines at least one performance with information contained in the global accompaniment object to generate a hybrid performance signal. The virtual instrument is a software object that maps the input stimuli provided by the user to specific notes specified in the interactive virtual instrument object.

### RELATED APPLICATIONS

This application is related to U.S. patent application Ser. No. ______ ______, entitled “A Multimedia Data File”, filed on the same date as this application, and assigned to the same assignee.

This application claims the priority of: U.S. Provisional Application Ser. No. 60/282,420, entitled “A Multimedia Data File”, and filed Apr. 9, 2001; U.S. Provisional Application Ser. No. 60/282,549, entitled “A Virtual Music System ”, and filed Apr. 9, 2001; U.S. Provisional Application Ser. No. 60/288,876, entitled “A Multimedia Data File”, and filed May 4, 2001; and U.S. Provisional Application Ser. No. 60/288,730, entitled “An Interactive Karaoke System”, and filed May 4, 2001.

This application herein incorporates by reference: U.S. Pat. No. 5,393,926, entitled “Virtual Music System”, filed Jun. 7, 1993, and issued Feb. 28, 1995; U.S. Pat. No. 5,670,729, entitled “A Virtual Music Instrument with a Novel Input Device”, filed May 11, 1995, and issued Sep. 23, 1997; and U.S. Pat. No. 6,175,070 B1, entitled “System and Method for Variable Music Annotation”, filed Feb. 17, 2000, and issued Jan. 16, 2001.

### TECHNICAL FIELD

This invention relates to interactive karaoke systems, and more particularly to interactive karaoke systems that play multipart data files.

### BACKGROUND

The Internet has allowed for the rapid dissemination of data throughout the world. This data can be in many forms (e.g., written, graphical, musical, etc.). Recently, a considerable portion of this transferred data has been musical data, in the form of Moving Picture Experts Group (MPEG or MP3) data files and Musical Instrument Digital Interface (MIDI) data files.

MIDI files, which were originally designed for the recording and playback of digital music on synthesizers, quickly gained favor in the personal computer arena. MIDI files, which do not represent the musical sound directly, provide information about how the music is to be reproduced. MIDI files are multi-track files, where each track of the file can be mapped to a discrete musical instrument. Further each track of the MIDI file includes the discrete notes to be played by that instrument. Since a MIDI file is essentially the computer equivalent of traditional sheet music for a particular song (as opposed to the sound recording for the song itself), these files tend to be small and compact when compared to files which actually record the music itself. However, MIDI files typically require some form of wave table or FM synthesizer chip to generate the sounds mapped by these notes within the MIDI file. Additionally, MIDI files tend to lack the richness and robustness of the actual sound recordings.

MPEG and MP3 files, unlike MIDI files, are the actual sound recordings of the music in question and, therefore, are full and robust. Typically, these files are 16 bit digital recordings similar in fashion to those found on musical compact disks. Unlike MIDI files, MPEG and MP3 files are single track files which do not include information concerning the specific musical notes or the instruments utilized in the recording. Additionally, as these files are the actual sound recordings, they tend to be quite large. However, while MIDI files typically require additional hardware in order to be played back, MPEG or MP3 files can quite often be played back with a minimal amount of specialized hardware.

Modern karaoke systems incorporate MIDI files to provide timing indicators to the user of the karaoke system to inform them of the lyrics of the song and the phrasing and timing of these lyrics. However, the level of interaction and choices provided to the user of the karaoke system tends to be quite limited and constrained.

### SUMMARY

According to an aspect of this invention, an interactive karaoke process, residing on a computer, for playing a multipart data file includes a multipart data file input process for receiving a multipart data file from a source. The multipart data file includes an interactive virtual instrument object and a global accompaniment object. The global accompaniment object includes at least a first synthesizer control file and at least a first sound recording file. A virtual instrument management process, responsive to the interactive virtual instrument object, generates at least one virtual instrument required to process the multipart data file. At least one virtual instrument prompts the user of that virtual instrument to provide an input stimuli to a virtual instrument input device associated with that virtual instrument. This generates a performance for that virtual instrument. An audio output process, responsive to the virtual instrument management process, combines at least one performance with information contained in the global accompaniment object to generate a hybrid performance signal. The virtual instrument is a software object that maps the input stimuli provided by the user to specific notes specified in the interactive virtual instrument object.

One or more of the following features may also be included. The first sound recording file includes a plurality of discrete sound files and the synthesizer control file controls the timing and sequencing of the playback of these discrete sound files. The synthesizer control file is a Musical Instrument Digital Interface (MIDI) data file. The sound recording file is a Moving Picture Experts Group (MPEG) data file.

The audio output process is configured to provide the hybrid performance signal to an audio amplification device.

The interactive virtual instrument object includes a virtual instrument definition file for each virtual instrument required to process the multipart data file. Each virtual instrument definition file includes a header for specifying what type of virtual instrument the virtual instrument definition file defines. The virtual instrument management process is configured to examine the header in each virtual instrument definition file to determine which virtual instruments need to be generated to process the multipart data file.

Each virtual instrument definition file includes a cue track for specifying a plurality of timing indicia indicative of the timing sequence of the input stimuli to be provided by the user. Each virtual instrument includes a video output process, responsive to the cue track, for displaying the plurality of timing indicia on a video display device viewable by the user.

Each virtual instrument definition file includes a performance track for specifying the pitch and timing of each note of the performance for that virtual instrument. The cue track and the performance track are synthesizer control files. The synthesizer control files are Musical Instrument Digital Interface (MIDI) data file. Each virtual instrument includes a pitch control process, responsive to the performance track, for controlling the pitch and timing of each note of the performance. Each of these notes is generated by the user in accordance with a discrete timing indicia displayed on the video display device.

Each global accompaniment object includes a sound font file for defining an acoustical characteristic for each virtual instrument. The sound font file includes a single digital sample of the musical instrument that corresponds to each virtual instrument. The frequency of this single digital sample is modified by the pitch control process in accordance with the frequency of the notes that constitute the performance of that virtual instrument.

A virtual instrument selection process allows the user of the interactive karaoke system to select which required virtual instrument the user is going to provide the input stimuli to via the virtual instrument's respective virtual instrument input device.

Each virtual instrument definition file includes a guide track for providing guide information to the user concerning the characteristics of the performance to be generated for that virtual instrument. This guide information includes pitch information, rhythm information, and timbre information. This guide track is a synthesizer control file. The synthesizer control file is a Musical Instrument Digital Interface (MIDI) data file. The guide track is a sound recording file. The sound recording file is a Moving Picture Experts Group (MPEG) data file.

Each virtual instrument includes a virtual instrument fill process, responsive to the user deciding not to provide the input stimuli to an unselected virtual instrument, for processing the guide track to generate a performance for that unselected virtual instrument.

Each virtual instrument includes an accompaniment management process for selectively subsidizing the performance of the virtual instrument by adding at least one supplemental note to that performance. Each virtual instrument definition file includes an accompaniment track for providing to the accompaniment management process a plurality of accompaniment indicia indicative of the supplemental notes to be provided by the accompaniment management process.

The virtual instrument management process includes a virtual instrument deletion process for deleting any virtual instruments that are no longer required to process the multipart data file.

The source is a remote music server or a local music server. The virtual instrument input device is a percussion input device, a string input device, or a vocal input device.

When utilized, the system described above provides a method for playing and processing multipart data files. The interactive karaoke system may be a computer program stored on a computer readable medium and processed by a computer incorporating a microprocessor. The computer readable medium may be a hard disk drive, a tape drive, an optical drive, a RAID array, a random access memory, a read only memory, etc.

One or more advantages can be provided from the above. A multipart data file which includes multiple information/data sources can be easily transmitted to and processed by an interactive karaoke system. As these multipart data files tend to be reasonable in size, these files can be transmitted using low bandwidth connections. The user can custom tailor the level of interactivity they desire when performing the songs associated with these data files on the interactive karaoke system. These multipart data files can be easily transferred and transmitted in a unitary fashion, enabling easy dissemination of music from centralized music repositories to remote interactive karaoke systems. Further, as multiple virtual instruments can be played simultaneously, multiple users can participate in the playback of these multipart data files.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagrammatic view of the interactive karaoke system.

Like reference symbols in the various drawings indicate like elements.

### DETAILED DESCRIPTION

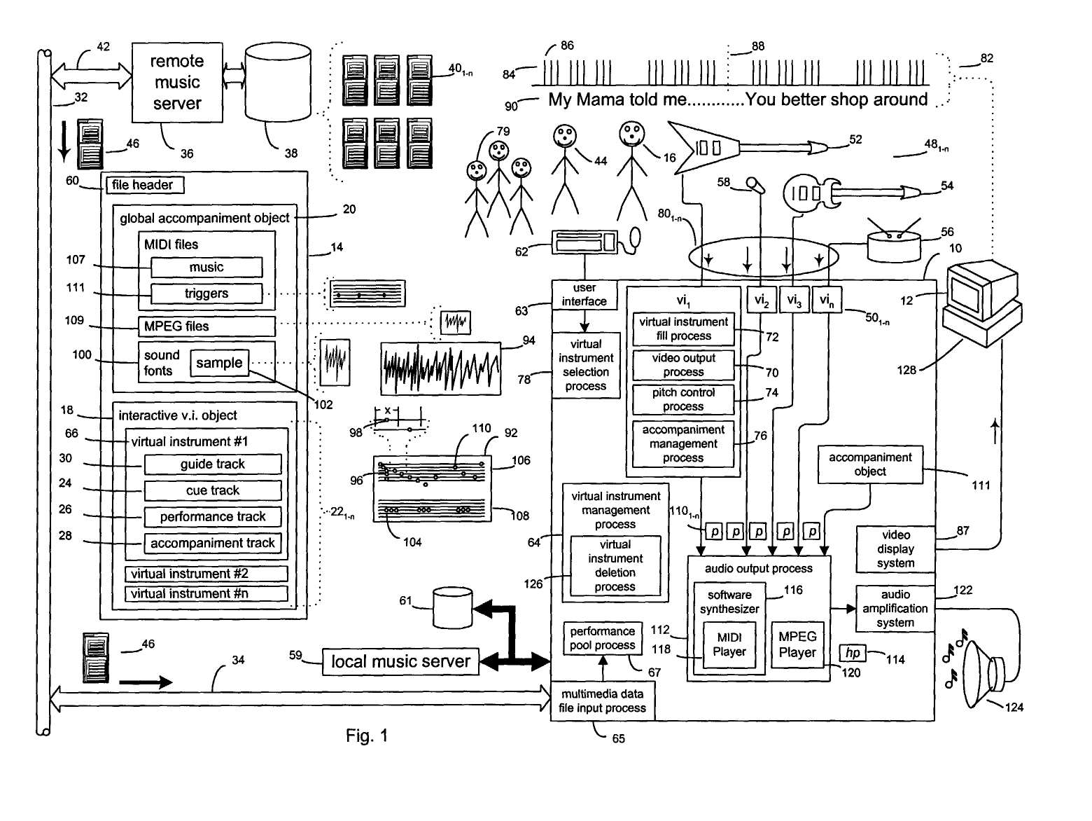

FIG. 1 shows an interactive karaoke system 10 that plays multipart data files 14, each of which corresponds to a particular song playable on system 10. During use of system 10, user 16 selects, via some form of user interface, the song that they wish to perform. Interactive karaoke system 10 is a multi-media, audio-visual music system that plays the musical accompaniment of a song while allowing user 16 to play along with the song by singing the song's lyrics and playing various “virtual” instruments, such as a bass guitar, a rhythm guitar, a lead guitar, drums, etc. Accordingly, this creates an interactive, entertainment experience for user 16.

Multipart data file 14 contains all the necessary information and files required for system 10 to accurately reproduce the song selected by user 16. Multipart data file 14 includes two major components, namely an interactive virtual instrument object 18 and a global accompaniment object 20.

Interactive virtual instrument object 18 includes one or more virtual instrument definition files 22₁₋ₙ, each of which corresponds to a virtual instrument playable by user 16. Each of these virtual instrument definition files 22₁₋ₙ includes various tracks to assist the user in generating a performance for that virtual instrument. If the user chooses to play a virtual instrument, a cue track 24 provides some form of timing indication to user 16 so that they know when to provide input stimuli to the virtual instrument. This input stimuli can be in many forms, such as strumming a virtual guitar pick on a tennis racket, singing lyrics into a microphone, striking a pen onto a drum pad, etc.

While vocals do not require any processing and are simply replayed by interactive karaoke system 10, input stimuli provided to non-vocal virtual instruments (e.g., guitars, basses, and drums) must be processed so that one or more notes, each having a specific pitch, timing and timbre, can be played for each of these input stimuli. A performance track 26 provides the information required to map each one of these input stimuli to a particular note or set of notes.

As it may be impossible or very difficult for user 16 to provide the input stimuli at the rate required by the song being played, an accompaniment track 28 subsidizes the performance provided by user 16. This feature is helpful for complex drum and guitar tracks. Further, a guide track 30 provides guide information to the user concerning the way in which the performance of that virtual instrument should sound. This feature is very handy for vocals, as the mere lyrics themselves do not provide information concerning their tonal characteristics. Additionally, if user 16 chooses not to play a virtual instrument, this guide track can be played to generate a performance for that virtual instrument.

There may be portions of the song that are not playable by user 16, such as background music and lyrics. Global accompaniment object 20 contains files concerning these various “non-interactive” tracks, as well as sound font files that help shape to tonal characteristics of the virtual instruments.

Interactive karaoke system 10 allows for the convenient retrieval of these multipart data files 14 from a remote source. These data files each represent a specific song playable on interactive karaoke system 10 and contain information concerning the various vocal and instrument tracks performable by user 16, as well as information about the various non-performable background tracks. If user 16 desires to sing the vocal track or play one of the various instrument tracks playable in the song, they can do so. This is easily accomplished through the use of virtual instruments and microphones. Alternatively, if user 16 chooses not to sing the vocal track or play any of the instrument tracks, interactive karaoke system 10 can play those tracks for the user and provide the user with a complete performance of the song.

Interactive karaoke system 10 is typically connected to a distributed computing network 32 through link 34. Link 34 can be any form of network connection, such as: a dial-up network connection via a modem; a direct network connection via a network interface card; a wireless network connection via any form of wireless communication chipset; and so forth. These devices could all be embedded into system 10. Distributed computing network 32 can be the Internet, an intranet, an extranet, a local area network (LAN), a wide area network (WAN), or any other form of network.

A remote music server 36, which is also connected to distributed computing network 32, includes a karaoke music database 38 that contains a plurality 40₁₋ₙ of these multipart data files 12. Database 38 and this plurality of multipart data files 40₁₋ₙ are accessible by interactive karaoke system 10. Accordingly, these files can be downloaded to system 10 when desired. Remote music server 36 is also connected to distributed computing network 32 via link 42. Link 42 can be any form of network connection, such as: a dial-up network connection via a modem; a direct network connection via a network interface card; a wireless network connection via any form of wireless communication chipset; and so forth. Each of these devices could be embedded into server 36.

When user 16 wishes to perform a song available on database 38 of remote music server 36, or when administrator 44 wishes to add a song to the list of songs (not shown) available for playback on interactive karaoke system 10, interactive karaoke system 10 will download the appropriate multipart data file(s) 46 from server 36 to system 10 via network 32 and links 34 and 42.

Interactive karaoke system 10 includes input ports (not shown) for various virtual instrument input devices 48₁₋ₙ. Each of these virtual instrument input devices 48₁₋ₙ is used in conjunction with a corresponding virtual instrument 50₁₋ₙ. These virtual instruments 50₁₋ₙ are software processes generated and maintained by interactive karaoke system 10. These virtual instruments 50₁₋ₙ are the subject of U.S. Pat. No. 5,393,926, entitled “Virtual Music System”, filed Jun. 7, 1993, issued Feb. 28, 1995, and herein incorporated by reference. Further, these virtual instrument input devices 48₁₋ₙ and virtual instruments 50₁₋ₙ are the subject of U.S. Pat. No. 5,670,729, entitled “A Virtual Music Instrument with a Novel Input Device”, filed May 11, 1995, issued Sep. 23, 1997, and incorporated herein by reference.

There are various types of virtual instrument input devices 48₁₋ₙ, such as string input device 52 (e.g., an electronic guitar pick for a virtual guitar) and 54 (e.g., an electronic guitar pick for a virtual bass guitar), percussion input device 56 (e.g., an electronic drum pad for a virtual drum), and vocal input device 58 (e.g., a microphone).

During use of interactive karaoke system 10, user 16 selects the song they wish to perform from a list (not shown) of songs performable on system 10. This list displays, for each available song, the information stored in the data file header 60. Various pieces of topical information may be included in this data file header 60, such as the song title, artist, release date, CD title, music category, etc. User 16 accesses and navigates this list of available songs via the combination of keyboard and mouse 62 (which is connected to user interface 63) and video display device 12. Alternatively, video display device 12 can incorporate touch screen technology, thus allowing user 16 to make the appropriate selections directly on the screen of video display device 12. This list of songs may only show those songs already downloaded from remote music server 36 or it may show all available songs, such as those already downloaded and those currently available from remote music server 36. Those songs already downloaded are typically stored on some form of local storage device, such as local music server 59 or local hard disk drive 61.

Once user 16 selects the song they wish to perform, interactive karaoke system 10 loads the appropriate multipart data file 46. Interactive karaoke system 10 includes a multimedia data file input process 65 for receiving the selected multipart data file 14 for processing. Once data file 14 is received, it is provided to performance pool process 67 for temporary storage. Additionally, if multipart data file 14 is compressed or encrypted, performance pool process 67 will decompress/decrypt data file 14 so that it is ready for processing.

Virtual instrument management process 64 examines multipart data file 14 to determine which virtual instruments need to be generated. This is accomplished by scanning the virtual instrument header 66 associated within each virtual instrument definition file 22₁₋ₙ. Virtual instrument header 66 contains all the relevant information concerning that particular virtual instrument, such as the virtual instrument name (e.g., lead guitar, rhythm guitar 1, rhythm guitar 2, vocals, etc.), the virtual instrument type (e.g., string, percussion, vocal, etc.), the difficulty level for playing that particular virtual instrument (e.g., beginner, intermediate, advanced, etc.), notes concerning the performance of this virtual instrument, etc.

Each virtual instrument 50₁₋ₙ generated by virtual instrument management process 64 contains the same components, each designed to work in conjunction with a particular portion of the multipart data file 14. Each virtual instrument 50₁₋ₙ contains a video output process 70, a virtual instrument fill process 72, a pitch control process 74, and an accompaniment management process 76.

Each of these virtual instruments 50₁₋ₙ generated is available to user 16 for playing. These available virtual instruments are presented to user 16 in the form of a list displayed on video display device 12, which user 16 navigates with via keyboard and mouse 60 connected to user interface 63. A virtual instrument selection process 78 allows user 16 to select which (if any) virtual instrument(s) they wish to play. Further, if additional users 79 play additional virtual instrument input devices 48₁₋ₙ and, therefore, additional virtual instruments 50₁₋ₙ, a virtual band could be essentially created.

Once this selection is made, the appropriate virtual instrument input devices 48₁₋ₙ are connected to the interactive karaoke system 10. For example, if the user wishes to sing the song's lyrics, a microphone 58 is connected to the appropriate input port. If user 16 wishes to play the song's guitar part, an electronic guitar pick 52 is connected to the corresponding port.

During the performance of the song selected, user 16 provides input stimuli to one or more of these virtual instrument input devices 48₁₋ₙ. These input stimuli generate one or more input signals 80₁₋ₙ, each of which corresponds to one of the virtual instrument input devices 48₁₋ₙ being played by user 16. These input signals 80₁₋ₙ are each provided to the corresponding virtual instruments 50₁₋ₙ and, therefore, interactive karaoke system 10. By providing these input stimuli, user 16 can interact with the performance of the song being played by interactive karaoke system 10. The form of input stimulus provided by user 16 varies in accordance with the type of virtual instrument input device 48₁₋ₙ and virtual instrument 50₁₋ₙ that user 16 is playing. For string input devices 52 and 54 that utilize an electronic guitar pick (not shown), user 16 would typically provide an input stimulus by swiping the virtual guitar pick on a hard surface. For percussion input device 56 that utilizes an electronic drum pad (not shown), user 16 would typically strike this drum pad with a hard object to provide the input stimulus. For vocal input device 58, user 16 typically sings into a microphone to provide the input stimulus.

Multipart data file 14 includes a virtual instrument definition file 22₁₋ₙ for each virtual instrument playable in that particular song. Each of these virtual instrument definition files 22₁₋ₙ includes a cue track 24 for providing a plurality of timing indicia 82 indicating the timing sequence of the input stimuli to be provided by user 16. Cue track 24 is some form of synthesizer control file 92, such as a MIDI file or equivalent, which stores these discrete timing indicia in a timed fashion. These timing indicia vary in form depending on the type of virtual instrument input device 48₁₋ₙ and virtual instrument 50₁₋ₙ being played by user 16. If virtual instrument input device 48₁₋ₙ is a string input device 52 or 54 or a percussion input device 56, timing indicia 82 are a series of spikes 84, somewhat similar to a EKG display. Each spike (for example, spike 86) graphically displays the point in time at which user 16 is to provide an input stimulus to the virtual instrument input device 48₁₋ₙ that user 16 is playing. This timing track is the subject of U.S. Pat. No. 6,175,070 B1, entitled “System and Method for Variable Music Annotation”, filed Feb. 17, 2000, issued Jan. 16, 2001, and incorporated herein by reference.

Additionally, instead of spikes 84, which only show the point in time at which the user is to provide an input stimulus, information concerning the pitch of the notes being played (in the form of a staff and note-based musical annotation, not shown) can also be displayed. While the user of the virtual instrument cannot control the pitch of the input stimuli provide to the virtual instrument input device, this display variation could enhance the enjoyment of user 16.

Timing indicia 82 for each virtual instrument 50₁₋ₙ are displayed on a video display device 12 (e.g., a CRT) that is viewable by user 16 and driven by a video output process 70 incorporated into that virtual instrument 50₁₋ₙ. Video output process 70 provides the required video information to video display system 87 (e.g., a video graphics card) which is connected to video display device 12. Specifically, the video output process 70 incorporated in each virtual instrument 50₁₋ₙ displays timing indicia 82 for that virtual instrument 50₁₋ₙ on a specific portion of the display screen of video display device 12.

Spikes 84 will typically be in a fixed position on video display device 16 and timing indicator 88 will repeatedly sweep from left to right across the screen of display device 16. Alternatively, spikes 84 can scroll to the left and user 16 will be prompted to provide an input stimulus when each individual spike (e.g., spike 86) passes under a fixed timing indicator 88. Further, if the virtual instrument input device 48₁₋ₙ is a vocal input device 58, the timing indicia 82 provided by cue track 24 is in the form of lyrics 90, such that individual words are sequentially highlighted in accordance with the specific point in time that each word is to be sung.

While virtual instrument management process 64 generates a virtual instrument 50₁₋ₙ for each virtual instrument definition file 22₁₋ₙ included in multipart data file 14, user 16 need not play each one of these virtual instruments 50₁₋ₙ. As stated above, user 16 can selectively choose which virtual instruments 50₁₋ₙ to play from those available for the particular song being played on interactive karaoke system 10. In the event that user 16 chooses to not play a particular virtual instrument 50₁₋ₙ, a guide track 30 provides the performance for this unselected virtual instrument. When this occurs, virtual instrument fill process 72 retrieves guide track 30 from the appropriate virtual instrument definition file 22₁₋ₙ which corresponds to this virtual instrument 50₁₋ₙ not chosen to be played. Therefore, regardless of the virtual instruments that user 16 chooses to play or not to play, interactive karaoke system 10 will always play a song which does not have any “holes” in it, as one or more guide tracks 30 would fill in any missing performances for the unselected virtual instruments. Additionally, if user 16 chooses to not play any virtual instruments 50₁₋ₙ, the guide track 30 for each “unselected” virtual instrument would provide a performance for that virtual instrument.

This guide track can be in one of several forms. Guide track 30 may be a synthesizer control file 92, such as a MIDI file. Synthesizer control files 92 provide the advantage of low bandwidth requirements but often sacrifice sound quality. Alternatively, guide track 30 may be a sound recording file 94, such as an MPEG or MP3 file, which provides higher sound quality but also has higher bandwidth requirements.

In addition to providing a “fill” track in the event that a user chooses not to play a virtual instrument, one or more guide tracks 30 can be selectively played to provide guide information to user 16. This guide information provides insight to the user concerning the pitch, rhythm, and timbre of the performance of that particular virtual instrument. For example, if user 16 is singing a song that they never heard before, guide track 30 can be played in addition to the performance sung by user 16. User 16 would typically play this guide track at a volume level lower than that of the vocals sang. Alternatively, user 16 may listen to guide track 30 through headphones. This guide track 30, which is played softly behind the vocal performance rendered by user 16, assists the user in providing an accurate performance for that vocal virtual instrument. Please realize that guide track 30 can be used to provide guide information for any virtual instrument, as opposed to only vocal virtual instruments.

When user 16 chooses to play a virtual instrument 50₁₋ₙ, user 16 provides input stimuli to the corresponding virtual instrument input device 48₁₋ₙ in accordance with the timing indicia 82 shown to the user. The appropriate virtual instrument 50₁₋ₙ receives these input stimuli in the form of an input signal 80₁₋ₙ. Each one of these input stimuli provided by the user is supposed to correspond to a specific timing indicia 84 displayed on video display device 12. However, depending on the skill level of the user, these input stimuli may directly or loosely correspond to these timing indicia 84. A performance track 26 provides a plurality of pitch control indicia 96 indicative of the pitch of each note of the performance for that virtual instrument. This performance track 26 for a particular virtual instrument is processed by a pitch control process 74 incorporated into that virtual instrument.

Pitch control process 74 controls the pitch and acoustical characteristics of each note of the performance of a virtual instrument 50₁₋ₙ. Pitch control process 74, which is incorporated in each virtual instrument 50₁₋ₙ, processes the input signal received by a particular virtual instrument. This input signal represents the individual notes played by user 16 on the corresponding virtual instrument input device 48₁₋ₙ. Pitch control process 108 sets the pitch of each of these notes in accordance with the discrete timing indicia 96 included in performance track 26. However, what must be realized is that user 16 might not provide input stimuli in a fashion and timing identical to that requested by timing indicia 82. For example, user 16 may provide these input stimuli early or late in time. Additionally, user 16 my only provide two input stimuli when timing indicia 82 requests three. Accordingly, each specific piece of pitch control indicia 96 has a time window (“x”) in which any input stimuli received by the corresponding virtual instrument within that time window will be mapped to a note who's pitch corresponds to that indicated by that piece of pitch control indicia. For example, if user 16 strums a virtual guitar pick three times in time window “x”, pitch control process 74 would expect user 16 to only strum this guitar pick once. However, since these three input stimuli were received within time window “x”, they would all be mapped to notes having the pitch specified by the piece of pitch control indicia 98 within window “x”. Accordingly, if pitch control indicia 98 specified a pitch of 300 Hertz, even though only one note was expected to be played within that window, three 300 Hertz notes would actually be played. This allows user 16 to improvise and customize their performance, further enhancing that user's enjoyment of the system.

As performance track 26 includes a plurality of pitch control indicia, each of which represents a discrete note having a certain pitch being played at a specific point in time, performance track 26 is a synthesizer control file 92, such as a MIDI file or equivalent.

In addition to controlling the pitch of the specific notes played by a user, pitch control process 74 sets the acoustical characteristics of each virtual instrument 50₁₋ₙ in accordance with the sound font file 100 for that particular virtual instrument.

The global accompaniment object 20 of multipart data file 14 includes a sound font file 100 for defining the acoustical characteristics of each virtual instrument 50₁₋ₙ required to reproduce the song represented by that file. Acoustical characteristics are, for example, the acoustical differences that make an overdriven lead guitar and a bass guitar sound differently. Acoustical characteristics also make a saxophone and a trombone sound differently. Sound font file 100 typically includes a digital sample 102 for each virtual instrument in a fashion similar to that of a wave table on a sound card. For example, if the sound font is for an overdriven guitar, the sample will be an actual recording of an overdriven guitar playing a defined note or frequency. If user 16 provides an input stimulus that, according to performance track 26, corresponds to a note having the same frequency as sample 102, sample 102 will be played without modification. However, if that input stimulus corresponds to a note which is at a different frequency than the frequency of sample 102, the frequency of sample 102 will be shifted by interactive karaoke system 10 so that it's frequency matches the pitch or frequency of the note being played.

Please realize that all virtual instruments do not utilize a performance track 26. A performance track is utilized for string input devices 52 and 54 and percussion input devices 56. This is due to the fact that interactive karaoke system 10 must generate a note having the appropriate pitch (as specified by performance track 26) for each input stimulus received. This is in direct contrast to vocal input device 58, in which the voice of user 16 is directly played by interactive karaoke system 10, as opposed to being interpreted and generated. As interactive karaoke system 10 must interpret and generate the appropriate note having the correct pitch for each input stimulus provided by user 16, upon virtual instrument 50₁₋ₙ receiving an input signal 48 corresponding to input stimuli provided by user 16, performance track 26 must provide that virtual instrument with information (i.e., pitch control indicia 96) concerning the pitch of that specific note.

As interactive karaoke system 10 allows user 16 to play any available virtual instrument 50₁₋ₙ (via their respective virtual instrument input devices 48₁₋ₙ), it is possible that user 16 may not be able to play virtual instrument input device 48₁₋ₙ with the requisite level of speed. For example, the guitar part in some songs utilize 1/32 notes (32 notes per second), which are typically too fast for any inexperienced guitar player to play. Further, drum tracks typically include notes played by a drummer using all four limbs, thus enabling the drummer to simultaneously play multiple bass drums, cymbals, tom-toms, etc. Accordingly, user 16 cannot provide input stimuli quickly enough to accurately reproduce the original performance of these instruments.

An accompaniment track 28 is included in each virtual instrument definition file 22₁₋ₙ incorporated into multipart data file 14. Accompaniment track 28 provides to accompaniment management process 76 a plurality of accompaniment indicia 104 indicative of the supplemental notes to be provided by accompaniment management process 76. These supplemental notes are incorporated into the overall performance of that virtual instrument. For example, if it is decided by administrator 44 that user 16 probably cannot provide input stimuli any quicker than eight times per second, accompaniment track 28 would supplement or subsidize the input stimuli provided by user 16 for any notes quicker than ⅛ notes (e.g., 1/16 notes, 1/32 notes, etc.). Alternatively, accompaniment management process 76 may monitor the rate at which user 16 is providing input stimuli to input device 48₁₋ₙ. This can be accomplished by monitoring the appropriate input signal 80₁₋ₙ provided to virtual instrument 50₁₋ₙ. In the event that the rate at which user 16 is providing input stimuli to input device 48₁₋ₙ is insufficient (when compared to the proper rate as defined by cue track 24), accompaniment management process 76 will subsidize the performance generated for that virtual instrument by adding supplemental notes to that performance. This subsidization process, which is accomplished by modifying the appropriate performance 110₁₋ₙ to incorporate the “missed” notes, increases the fullness and robustness of the individual performances 110₁₋ₙ and the hybrid performance 114, resulting in a more enjoyable experience for user 16.

This subsidization occurs when accompaniment management process 76 adds additional notes to the performance generated by user 16. This results in accompaniment track 28 acting like a filler for the notes generated by user 16, such that the notes missing from the user's performance can be compensated for. Additionally, as it would be impossible for a user 16 playing a virtual drum 56 to simultaneously play a cymbal track and a drum track, the cymbal track would typically be provided for by accompaniment track 28. Accordingly, in this situation, accompaniment indicia 104 would be indicative of the cymbal notes to be added to the performance generated by user 16.

As accompaniment track 28 includes a plurality of accompaniment indicia 104, each of which represents a discrete note having a certain pitch being played at a specific point in time, accompaniment track 28 is a synthesizer control file 92, such as a MIDI file or equivalent.

As stated above, cue track 24, performance track 26, and accompaniment track 28 are synthesizer control files 92. Typically, these file are asynchronous in nature, in that their processing is not dependant on the occurrence or completion of another process. Additionally, these files are multi-element in that they contain numerous discrete timing and pitch indicia. Further, synthesizer control files 92 can include multiple tracks 106 and 108 and, therefore, are multi-channel. While MIDI files can currently include up to 16 tracks of information for a specific instrument, cue track 24, performance track 26, and accompaniment track 28 each typically include only one track 106. These information tracks 106 include a plurality of discrete pieces of information 110. These pieces of information 110 correspond to: the timing indicia 82 of cue track 24; the accompaniment indicia 104 of accompaniment track 28; and the pitch control indicia 96 of performance track 26.

Guide track 30 may be either a synthesizer control file 92 (e.g. a MIDI file or equivalent) or a sound recording file 94 (e.g., an MPEG file, MP3 file, WAV file, or equivalent). If guide track 30 is a synthesizer control file 92, it will include a plurality of discrete notes which, when played by interactive karaoke system 10, will generate the performance for the virtual instrument not selected to be played by user 16. Alternatively, if guide track 30 is a sound recording file 94, guide track 30 will merely be a sound recording of the real instrument that corresponds to the non-selected virtual instrument being played. For example, if user 16 chooses not to play the virtual guitar (i.e., string input device 52) and the guide track 30 for string input device 52 is an MPEG file, guide track 30 would simply be a sound recording of a person playing on a real guitar the notes that were supposed to be played on the virtual guitar.

As each virtual instrument definition file 22₁₋ₙ included in multipart data file 14 is processed, a performance 110₁₋ₙ for each of these virtual instrument is generated. These performances include: any notes played by user 16 via a virtual instrument input device 48₁₋ₙ; any notes subsidized by accompaniment management process 76/accompaniment track 28; and any “filler” performance generated by virtual instrument fill process 72/guide track 30.

As stated above, global accompaniment object 20 contains files concerning the various “non-interactive” music tracks, such as background instruments and vocals. The files representing these “non-interactive” music tracks can be synthesizer control files 92, sound recording files 94, or a combination of both. Since synthesizer control files tend to be small, it is desirable to utilize a MIDI background track 107 in a song. However, MIDI files do not contain the robustness and fullness of actual sound recordings. Unfortunately, since sound recording files, such as MPEG and MP3 files, are quite large in size, this may prohibit this file format from being utilized to provide a complete background music track or backing vocal track. Fortunately, these background tracks typically include large portions of silence. Therefore, it is desirable to break these background tracks into discrete portions 109 so that storage space and bandwidth are not wasted saving long passages of silence. For example, if a song has five identical fifteen second background choruses and these five choruses are each separated by forty-five seconds of silence, this background track recorded in it entirety would be four minutes and fifteen seconds long. However, there is only fifteen seconds of unique data is this track, in that this chunk of data is repeated five times. Accordingly, by recording only the unique portions 109 of data, a four minute and fifteen second background track can be reduced to only fifteen seconds, resulting in a 94% file size reduction. By utilizing a MIDI trigger file 111 to initiate the timed and repeated playback of this fifteen second data track 109 (once per minute for five minutes), a background track can be created which has the space saving characteristics of a MIDI file yet the robust sound characteristics of a MPEG file.

Interactive karaoke system 10, while processing global accompaniment object 20, generates an accompaniment object 111, which generates a performance for these “non-interactive” background tracks.

Interactive karaoke system 10 includes an audio output process 112 that combines these individual performances 110₁₋ₙ to generate a hybrid performance 114 for the song being played. As stated above, any performance 110₁₋ₙ or a portion of any performance may be either a synthesizer control file 92 or a sound recording file 94. Accordingly, audio output process 112 includes a software synthesizer 116 for converting any synthesizer control files 92 into musical performances. This is accomplished through the use of some form of player or decoder. MIDI player 118 processes any synthesizer control files to decode them and generate the musical performance for that file. During this decoding process, the appropriate sound font 100 is utilized so that the characteristics of the resulting musical performances are properly defined. If either a whole performance 110₁₋ₙ or a portion of a performance is a sound recording file 94, a different player/decoder must be used. MPEG player 120 processes any sound recording file 94 to decode the file and generate the musical performance for that file. A typical embodiment of audio output process 112 is a sound card which incorporates MIDI capabilities (for the synthesizer control files), MPEG capabilities (for the sound recording files), and mixing capabilities (to combine these multiple audio streams).

Hybrid performance signal 114 is provided to audio amplification system 122, which is connected to speaker system 124. Audio amplification system 122 is any form of amplification device, such as a built-in low wattage amplifier or a stand-alone hi-wattage power amplifier. Additionally, audio amplification system 122 may perform standard preamplification functions, such as impedance matching, voltage/signal level matching, tone (bass/treble) control, etc.

Once multipart data file 14 is processed and completely performed, the virtual instruments 50₁₋ₙ required to process that file are no longer needed. However, they may be needed again to process the next data file if that file utilizes identical virtual instruments. A virtual instrument deletion process 126 deletes any virtual instruments that are no longer needed to process data file 14. This deletion process can occur at various times. For example, virtual instrument deletion process 126 can be executed each time the processing of a data file 14 is completed. Alternatively, deletion process 126 can be executed after the virtual instruments 50₁₋ₙ for the next file are loaded but before that file is processed. This would bolster the efficiency of interactive karaoke system 10, as identical virtual instrument 50₁₋ₙ required to process multiple consecutive files would only be created and loaded once.

While, thus far, interactive karaoke system 10 has been described exclusively as a system, it should be understood that the use of interactive karaoke system 10 also provides a method for playing and processing multipart data files 14. Further, it should be understood that interaction karaoke system 10 may be a computer program (i.e., lines of code/computer instructions) which are stored on a computer readable medium (not shown). This computer readable medium is typically incorporated into a computer 128 having a microprocessor (not shown). Computer 128 may be a personal computer, a network server, an array of network servers, a single board computer, etc. The computer readable medium may be a hard disk drive (e.g. local hard disk drive 61), a tape drive, an optical drive, a RAID (Redundant Array of Independent Disks) array, random access memory, read only memory, etc.

Additionally, while multipart data file 14 has been described as being transferred in a unitary fashion, this is for illustrative purposes only. Each multipart data file is simply a collection of various components (e.g., interactive virtual instrument object 18 and global accompaniment object 20), each of which includes various subcomponents and tracks. Accordingly, in addition to the unitary fashion described above, these components and/or subcomponents may also be transferred individually or in various groups.

A number of embodiments of the invention have been described. Nevertheless, it will be understood that various modifications may be made without departing from the spirit and scope of the invention. Accordingly, other embodiments are within the scope of the following claims.

What is claimed is:

1. A method for playing a multipart data file on an interactive karaoke system comprising:
receiving a multipart data file from a source, the multipart data file including an interactive virtual instrument object and a global accompaniment object, wherein the global accompaniment object includes at least a first synthesizer control file and at least a first sound recording file;
generating at least one virtual instrument required to process the multipart data file;
prompting the user of at least one virtual instrument to provide an input stimuli to the virtual instrument input device associated with that virtual instrument to generate a performance for that virtual instrument; and
combining at least one performance with information contained in the global accompaniment object to generate a hybrid performance signal;
wherein the virtual instrument is a software object that maps the input stimuli provided by the user to specific notes specified in the interactive virtual instrument object.

2. The method for playing a multipart data file of claim 1 wherein the at least a first sound recording file includes a plurality of discrete sound files and the synthesizer control file controls the timing and sequencing of the playback of these discrete sound files.

3. The method for playing a multipart data file of claim 1 further comprising providing the hybrid performance signal to an audio amplification device.

4. The method for playing a multipart data file of claim 1 wherein the interactive virtual instrument object includes a virtual instrument definition file for each required virtual instrument, each virtual instrument definition file including a header for specifying what type of virtual instrument that virtual instrument definition file defines.

5. The method for playing a multipart data file of claim 4 further comprising examining each header of each virtual instrument definition file to determine which virtual instruments need to be generated to process the multipart data file.

6. The method for playing a multipart data file of claim 1 wherein the interactive virtual instrument object includes a virtual instrument definition file for each required virtual instrument, each virtual instrument definition file including a cue track for specifying a plurality of timing indicia indicative of the timing sequence of the input stimuli to be provided by the user.

7. The method for playing a multipart data file of claim 7 further comprising displaying the plurality of timing indicia on a video display device viewable by the user.

8. The method for playing a multipart data file of claim 1 wherein the interactive virtual instrument object includes a virtual instrument definition file for each required virtual instrument, each virtual instrument definition file including a performance track for specifying the pitch and timing of each note of the performance for that virtual instrument.

9. The method for playing a multipart data file of claim 8 further comprising controlling the pitch and timing of each note of the performance, wherein each note is generated by the user in accordance with a discrete timing indicia displayed on the video display device.

10. The method for playing a multipart data file of claim 1 wherein the global accompaniment object including a sound font file for defining an acoustical characteristic for each virtual instrument.

11. The method for playing a multipart data file of claim 1 further comprising allowing the user of the interactive karaoke system to select which required virtual instrument the user is going to provide input stimuli to via the instrument's respective virtual instrument input device.

12. The method for playing a multipart data file of claim 1 wherein the interactive virtual instrument object includes a virtual instrument definition file for each required virtual instrument, each virtual instrument definition file including a guide track for providing guide information to the user concerning the characteristics of the performance to be generated for that virtual instrument.

13. The method for playing a multipart data file of claim 12 further comprising processing the guide track to generate a performance for a virtual instrument not selected to be played by the user.

14. The method for playing a multipart data file of claim 1 further comprising selectively subsidizing the performance of a virtual instrument by adding at least one supplemental note to that performance.

15. The method for playing a multipart data file of claim 14 wherein the interactive virtual instrument object includes a virtual instrument definition file for each required virtual instrument, each virtual instrument definition file including an accompaniment track for specifying a plurality of accompaniment indicia indicative of the supplemental notes utilized to subsidize the performance of that virtual instrument.

16. The method for playing a multipart data file of claim 1 further comprising deleting any virtual instruments which are no longer required to process of the multipart data file.

17. A method for playing a multipart data file on an interactive karaoke system comprising:
receiving a multipart data file from a source, the multipart data file including an interactive virtual instrument object and a global accompaniment object;
generating at least one virtual instrument required to process the multipart data file;
prompting the user of at least one virtual instrument to provide an input stimuli to the virtual instrument input device associated with that virtual instrument to generate a performance for that virtual instrument; and
combining at least one performance with information contained in the global accompaniment object to generate a hybrid performance signal;
wherein the virtual instrument object includes a guide track for at least one required virtual instrument to provide guide information to the user concerning the characteristics of the performance to be generated for that virtual instrument;
wherein the virtual instrument is a software object that maps the input stimuli provided by the user to specific notes specified in the interactive virtual instrument object.

18. An interactive karaoke process, residing on a computer, for playing a multipart data file comprising:
a multipart data file input process for receiving a multipart data file from a source, said multipart data file including an interactive virtual instrument object and a global accompaniment object, wherein said global accompaniment object includes at least a first synthesizer control file and at least a first sound recording file;
a virtual instrument management process, responsive to said interactive virtual instrument object, for generating at least one virtual instrument required to process said multipart data file, wherein at least one said virtual instrument prompts the user of that virtual instrument to provide an input stimuli to a virtual instrument input device associated with that virtual instrument, thus generating a performance for that virtual instrument;
an audio output process, responsive to said virtual instrument management process, for combining at least one performance with information contained in said global accompaniment object to generate a hybrid performance signal;
wherein said virtual instrument is a software object that maps said input stimuli provided by the user to specific notes specified in said interactive virtual instrument object.

19. The interactive karaoke process of claim 18 wherein said at least a first sound recording file includes a plurality of discrete sound files, wherein said synthesizer control file controls the timing and sequencing of the playback of said discrete sound files.

20. The interactive karaoke process of claim 18 wherein said synthesizer control file is a Musical Instrument Digital Interface (MIDI) data file.

21. The interactive karaoke process of claim 18 wherein said sound recording file is a Moving Picture Experts Group (MPEG) data file.

22. The interactive karaoke process of claim 18 wherein said audio output process is configured to provide said hybrid performance signal to an audio amplification device.

23. The interactive karaoke process of claim 18 wherein said interactive virtual instrument object includes a virtual instrument definition file for each said virtual instrument required to process said multipart data file.

24. The interactive karaoke process of claim 23 wherein each said virtual instrument definition file includes a header for specifying what type of virtual instrument said virtual instrument definition file defines.

25. The interactive karaoke process of claim 24 wherein said virtual instrument management process is configured to examine each said header of each said virtual instrument definition file to determine which said virtual instruments need to be generated to process said multipart data file.

26. The interactive karaoke process of claim 23 wherein each said virtual instrument definition file includes a cue track for specifying a plurality of timing indicia indicative of the timing sequence of said input stimuli to be provided by said user.

27. The interactive karaoke process of claim 26 wherein each said virtual instrument includes a video output process, responsive to said cue track, for displaying said plurality of timing indicia on a video display device viewable by said user.

28. The interactive karaoke process of claim 27 wherein each said virtual instrument definition file includes a performance track for specifying the pitch and timing of each note of said performance for that virtual instrument.

29. The interactive karaoke process of claim 28 wherein said cue track and said performance track are synthesizer control files.

30. The interactive karaoke process of claim 29 wherein said synthesizer control files are Musical Instrument Digital Interface (MIDI) data file.

31. The interactive karaoke process of claim 28 wherein each said virtual instrument includes a pitch control process, responsive to said performance track, for controlling the pitch and timing of each said note of said performance, wherein each said note is generated by said user in accordance with a discrete timing indicia displayed on said video display device.

32. The interactive karaoke process of claim 31 wherein each said global accompaniment object includes a sound font file for defining an acoustical characteristic for each virtual instrument.

33. The interactive karaoke process of claim 32 wherein said sound font file includes a single digital sample of the musical instrument which corresponds to each virtual instrument, wherein the frequency of each sample is modified by said pitch control process in accordance with the frequency of said notes which constitute said performance of that virtual instrument.

34. The interactive karaoke process of claim 28 further comprising a virtual instrument selection process for allowing the user of said interactive karaoke system to select which said required virtual instrument said user is going to provide said input stimuli to via said virtual instrument's respective virtual instrument input device.

35. The interactive karaoke process of claim 34 wherein each said virtual instrument definition file includes a guide track for providing guide information to the user concerning the characteristics of the performance to be generated for that virtual instrument.

36. The interactive karaoke process of claim 35 wherein said guide information includes pitch information, rhythm information, and timbre information.

37. The interactive karaoke process of claim 35 wherein said guide track is a synthesizer control file.

38. The interactive karaoke process of claim 37 wherein said synthesizer control file is a Musical Instrument Digital Interface (MIDI) data file.

39. The interactive karaoke process of claim 35 wherein said guide track is a sound recording file.

40. The interactive karaoke process of claim 39 wherein said sound recording file is a Moving Picture Experts Group (MPEG) data file.

41. The interactive karaoke process of claim 35 wherein each said virtual instrument includes a virtual instrument fill process, responsive to said user deciding not to provide said input stimuli to an unselected virtual instrument, for processing said guide track to generate a performance for said unselected virtual instrument.

42. The interactive karaoke process of claim 23 wherein each said virtual instrument includes an accompaniment management process for selectively subsidizing said performance of said virtual instrument by adding at least one supplemental note to that performance.

43. The interactive karaoke process of claim 42 wherein each said virtual instrument definition file includes an accompaniment track for providing to said accompaniment management process a plurality of accompaniment indicia indicative of said supplemental notes to be provided by said accompaniment management process.

44. The interactive karaoke process of claim 18 wherein said virtual instrument management process includes a virtual instrument deletion process for deleting any virtual instruments which are no longer required to process said multipart data file.

45. The interactive karaoke process of claim 18 wherein said source is a remote music server.

46. The interactive karaoke process of claim 18 wherein said source is a local music server.

47. The interactive karaoke process of claim 18 wherein said virtual instrument input device is a percussion input device.

48. The interactive karaoke process of claim 18 wherein said virtual instrument input device is a string input device.

49. The interactive karaoke process of claim 18 wherein said virtual instrument input device is a vocal input device.

50. An interactive karaoke process, residing on a computer, for playing a multipart data file comprising:
a multipart data file input process for receiving a multipart data file from a source, said multipart data file including an interactive virtual instrument object and a global accompaniment object;
a virtual instrument management process, responsive to said interactive virtual instrument object, for generating at least one virtual instrument required to process said multipart data file, wherein at least one said virtual instrument prompts the user of that virtual instrument to provide an input stimuli to a virtual instrument input device associated that virtual instrument, thus generating a performance for that virtual instrument;
an audio output process, responsive to said virtual instrument management process, for combining at least one performance with information contained in said global accompaniment object to generate a hybrid performance signal;
wherein said interactive virtual instrument object includes a guide track for at least one required virtual instrument that provides guide information to the user concerning the characteristics of the performance to be generated for that virtual instrument;
wherein said virtual instrument is a software object that maps said input stimuli provided by the user to specific notes specified in said interactive virtual instrument object.

51. The interactive karaoke process of claim 50 wherein said guide information includes pitch information, rhythm information, and timbre information.

52. A computer program product residing on a computer readable medium having a plurality of instructions stored thereon which, when executed by the processor, cause that processor to:
receive a multipart data file from a source, the multipart data file including an interactive virtual instrument object and a global accompaniment object, wherein the global accompaniment object includes at least a first synthesizer control file and at least a first sound recording file;
generate at least one virtual instrument required to process the multipart data file;
prompt the user of at least one virtual instrument to provide an input stimuli to the virtual instrument input device associated with that virtual instrument to generate a performance for that virtual instrument; and
combine at least one performance with information contained in the global accompaniment object to generate a hybrid performance signal;
wherein the virtual instrument is a software object that maps the input stimuli provided by the user to specific notes specified in the interactive virtual instrument object.

53. The computer program product of claim 52 wherein said computer readable medium is a random access memory (RAM).

54. The computer program product of claim 52 wherein said computer readable medium is a read only memory (ROM).

55. The computer program product of claim 52 wherein said computer readable medium is a hard disk drive.

56. A computer program product residing on a computer readable medium having a plurality of instructions stored thereon which, when executed by the processor, cause that processor to:
receive a multipart data file from a source, the multipart data file including an interactive virtual instrument object and a global accompaniment object;
generate at least one virtual instrument required to process the multipart data file;
prompt the user of at least one virtual instrument to provide an input stimuli to the virtual instrument input device associated with that virtual instrument to generate a performance for that virtual instrument; and
combine at least one performance with information contained in the global accompaniment object to generate a hybrid performance signal;
wherein the virtual instrument object includes a guide track for at least one required virtual instrument to provide guide information to the user concerning the characteristics of the performance to be generated for that virtual instrument;
wherein the virtual instrument is a software object that maps the input stimuli provided by the user to specific notes specified in the interactive virtual instrument object.

57. A processor and memory configured to:
receive a multipart data file from a source, the multipart data file including an interactive virtual instrument object and a global accompaniment object, wherein the global accompaniment object includes at least a first synthesizer control file and at least a first sound recording file;
generate at least one virtual instrument required to process the multipart data file;
prompt the user of at least one virtual instrument to provide an input stimuli to the virtual instrument input device associated with that virtual instrument to generate a performance for that virtual instrument; and
combine at least one performance with information contained in the global accompaniment object to generate a hybrid performance signal;
wherein the virtual instrument is a software object that maps the input stimuli provided by the user to specific notes specified in the interactive virtual instrument object.

58. The processor and memory of claim 57 wherein said processor and memory are incorporated into a personal computer.

59. The processor and memory of claim 57 wherein said processor and memory are incorporated into a single board computer.

60. The processor and memory of claim 57 wherein said processor and memory are incorporated into a network server.

61. A processor and memory configured to:
receive a multipart data file from a source, the multipart data file including an interactive virtual instrument object and a global accompaniment object;
generate at least one virtual instrument required to process the multipart data file;
prompt the user of at least one virtual instrument to provide an input stimuli to the virtual instrument input device associated with that virtual instrument to generate a performance for that virtual instrument; and
combine at least one performance with information contained in the global accompaniment object to generate a hybrid performance signal;
wherein the virtual instrument object includes a guide track for at least one required virtual instrument to provide guide information to the user concerning the characteristics of the performance to be generated for that virtual instrument;
wherein the virtual instrument is a software object that maps the input stimuli provided by the user to specific notes specified in the interactive virtual instrument object.
